(19) United States
(12) Patent Application Publication
(10) Pub. No.: US 2008/0015979 A1
(43) Pub. Date: Jan. 17, 2008

(54) Web-based searching for payment card products with credit pre-approvals

(76) Inventor: Shanan Bentley, Baldwin, NY (US)

Correspondence Address: BUCKLEY, MASCHOFF & TALWALKAR LLC, 50 LOCUST AVENUE, NEW CANAAN, CT, 06840, US

(21) Appl. No.: 11/486,916

(22) Filed: Jul. 14, 2006

(51) Int. Cl. G06Q 40/00

(52) U.S. Cl. 705/38

(57) ABSTRACT

A method includes receiving input at a website from a user to indicate at least one preference of the user in regard to a payment card product that the user wishes to acquire. The method further includes selecting at least one payment card product from a plurality of payment card products. The payment card in question is selected based at least in part on the preference indicated by the user. The method also includes requesting a pre-approval credit evaluation of the user and receiving a result of the pre-approval credit evaluation. In addition, the method includes downloading a display page to the user to indicate the selected payment card product and to indicate that the user has been pre-approved for the payment card product.

### BACKGROUND

It is a known practice for a payment card association* to maintain a website and to allow visitors to the website to search for particular payment card products branded by the association. For example, the website visitor may be prompted to enter the visitor's preferred payment card features, such as annual fee (or lack thereof), interest rate and/or “rewards”. On the basis of the preferred feature or features entered by the website visitor, the association's server computer searches a database of payment card products to select a number of products that best match the visitor's preferences. The association's server computer then downloads one or more results display pages to the visitor's computer to inform the visitor of the results of the search. Each display page may include a number of entries, each of which corresponds to a respective payment card product. Each entry may include a respective hypertext link. If the website visitor clicks on (actuates) the link, he/she is re-directed to a website maintained by the issuing financial institution (issuer) of the corresponding payment card product. At the issuer website, the now-re-directed website visitor may be prompted to fill out an online application for the corresponding payment card product. * The assignee hereof, MasterCard International, Inc., is a very prominent example of a payment card association.

The above-described association website feature, often referred to as a “find-a-card” feature, works well for its intended purposes. (See, for example, http://www.mastercard.com/us/personal/en/findacard/creditcard_search.html.) However, the present inventor has recognized that there are opportunities to increase the convenience and effectiveness of the “find-a-card” feature from the point of view of prospective customers, issuers, and/or the association itself.

### BRIEF DESCRIPTION OF THE DRAWINGS

FIG. 1 is a block diagram representation of aspects of a payment card system provided in accordance with some embodiments of the present invention.

FIG. 2 is a block diagram of a server computer employed by a payment card association in the system of FIG. 1.

FIGS. 3A-3C together form a flow chart that illustrates a process that may be performed by the server computer of FIG. 2.

FIGS. 4-8 show screen display pages that may be downloaded from the server computer of FIG. 2 as part of the process of FIGS. 3A-3C.

FIG. 9 is a block diagram representation of aspects of a payment card system provided in accordance with some alternative embodiments of the present invention.

### DETAILED DESCRIPTION

In general, and for the purpose of introducing concepts of embodiments of the present invention, a find-a-card feature of a card association website solicits, from a website visitor, information to identify the visitor. At the same time the association website also solicits at least one of the visitor's preferred payment card product features. The association server computer searches a database of card products to find one or more matching payment card products. If the search results produce a product that is enabled for pre-approval, the association server uses the visitor identifying information to request another computer, such as a credit bureau server computer, to perform a credit evaluation to allow the card product to be presented to the visitor on a “pre-approved” basis. If the visitor passes the pre-approval credit evaluation, then the association server downloads to the visitor's computer a search results page including an entry for the product to indicate that the visitor has been pre-approved for the product.

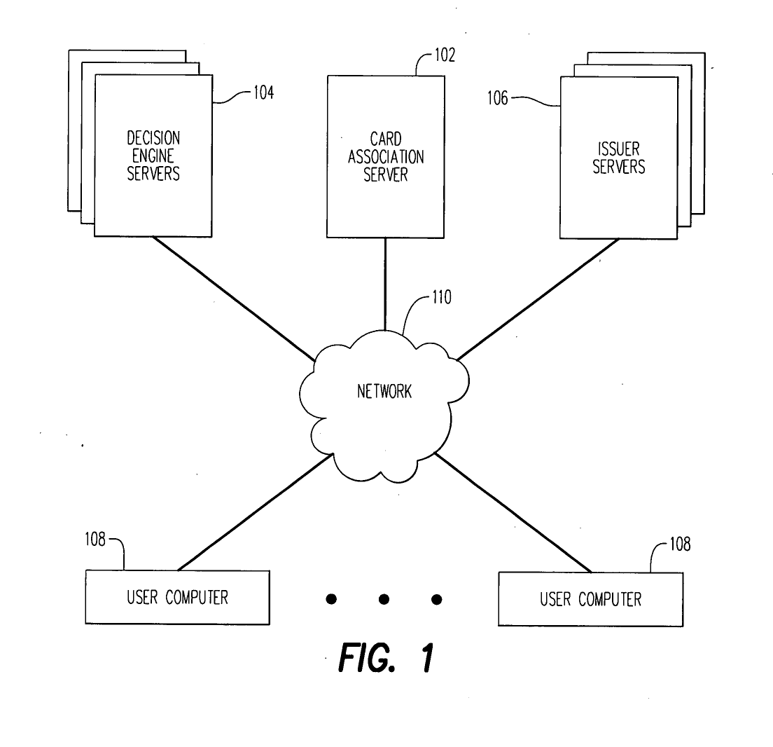

FIG. 1 is a block diagram representation of aspects of a payment card system 100 provided in accordance with some embodiments of the present invention.

The payment card system 100 may include a server computer 102 that is operated by a payment card association, such as MasterCard International Incorporated, the assignee hereof. The server computer 102 will be described in greater detail below. Suffice it to say for the moment that the server computer 102 may operate a website for the card association, akin for example to the website accessible at www.mastercard.com. The card association website may include a “find-a-card” feature, enhanced in accordance with aspects of the invention, as described below.

The payment card system 100 also may include one or more server computers 104 to operate decision engines to make credit evaluations with respect to eligibility of individuals and/or businesses for payment cards. In some cases, the decision engine servers 104 may be operated by one or more credit bureaus. Thus in some cases the decision engine servers 104 may be referred to as “credit bureau servers”. However, this should not be understood to preclude the decision engine servers from being operated, in at least some instances, by entities other than credit bureaus. As will be seen, the decision engine server computers 104 may operate in accordance with aspects of the invention to receive requests for pre-approval credit evaluations from the card association server computer 102. Moreover, the decision engine server computers 104 may perform the requested credit evaluations and report results of the same back to the association server computer 102. (The number of decision engine servers 104 may be more or fewer than the three servers explicitly shown in the drawing.)

Further, the payment card system 100 may include one or more server computers 106 operated by one or more financial institutions (issuers) that issue payment cards branded by the association which operates the server 102. As will be seen, the issuer server computers 106 may process online payment card account applications from visitors to the card association website who are redirected to websites maintained by the issuer servers 106. In addition, and as a supplement to or replacement for some or all of the credit bureau servers 104 (which need not be present in some embodiments of the payment card system 100), the issuer server computers may perform pre-approval credit evaluations in response to requests from the association server 102.

The payment card system 100 may also include user computers 108, which interact with the association server 102 from time to time via a communication network 110 such as the Internet. The user computers 108 may be, for example, personal computers, laptop computers, or the like. (The term “user computer” should also be understood to encompass other types of devices, such as web-enabled PDAs, web-enabled cellular telephones, etc.) For example, as will already be clear, the user computers may be employed by individual users (website visitors/prospective or existing customers) to access the card association website maintained by the association server 102. Of particular relevance, the user computers 108 may be operated to access the enhanced “find-a-card” feature of the card association website.

It will be noted that the credit bureau servers 104 and the issuer servers 106 are also shown as connected to the network 110 to allow interaction between those servers and the association server 102. In actual practice the network 110 need not be entirely a single network such as the Internet. For example the network 110 may include two or more networks (including the Internet) and/or one or more private data communication channels. It will also be appreciated that the user computers 108 may interact with the issuer servers 106 via the network 110.

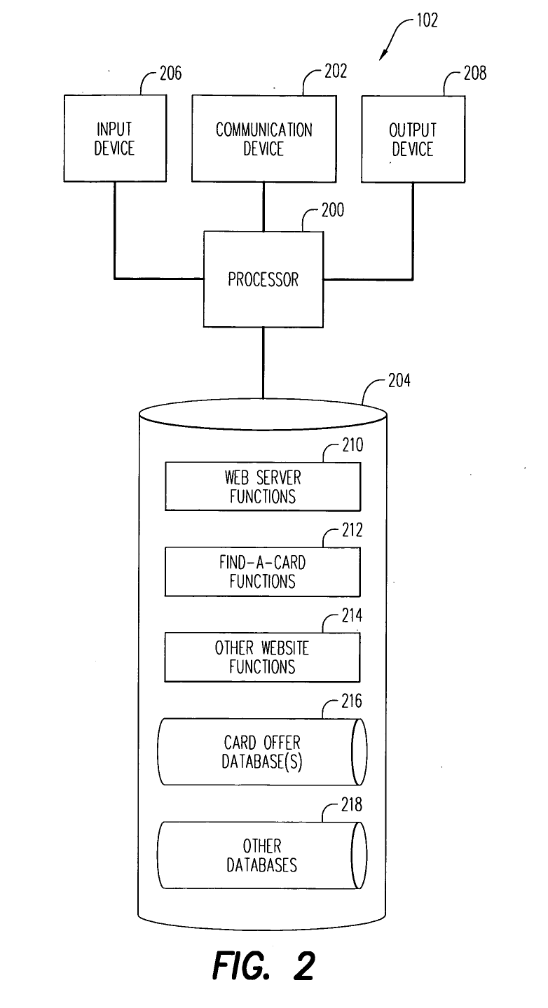

FIG. 2 is a block diagram of the payment card association server computer 102 as provided in accordance with some embodiments. The server computer 102 may include a computer processor 200 operatively coupled to a communication device 202, a storage device 204, an input device 206 and an output device 208.

The computer processor 200 may be constituted by one or more conventional processors, and may, for example, comprise RISC-based or other types of processors. Processor 200 operates to execute processor-executable process steps so as to control the server computer 102 to provide desired functionality.

Communication device 202 may be used to facilitate communication with, for example, other devices (such as user computers 108, credit bureau servers 104, issuer servers 106 and/or personal computers or terminals/workstations (not shown) operated by human operators employed by the card association and/or its contractors). Communication device 202 thus may include numerous ports to allow for simultaneous communication with a number of other devices. Communication device 202 is therefore preferably configured with hardware suitable to physically interface with desired external devices and/or network connections. For example, communication device 202 may comprise an Ethernet connection to a local area network through which the server computer 102 may receive and transmit information over the Internet. In addition or alternatively, the communication device 202 may couple the server computer 102 to one or more private communication networks by which the server computer 102 may communicate with credit bureau servers 104 and/or issuer servers 106.

Input device 206 may comprise, for example, a keyboard, a keypad, a mouse or other pointing device, a microphone, knob or switch, an infra-red (IR) port, a docking station, and/or a touch screen. Output device 208 may comprise, for example, a display (e.g., a display screen), a speaker, and/or a printer.

Storage device 204 may comprise any appropriate information storage device, including combinations of magnetic storage devices (e.g., magnetic tape and hard disk drives), optical storage devices such as CDs and/or DVDs, and/or semiconductor memory devices such as Random Access Memory (RAM) devices and Read Only Memory (ROM) devices, as well as so-called flash memory.

Storage device 204 stores one or more programs for controlling processor 200. The programs comprise processor-executable process steps of server computer 102, including process steps that constitute processes provided in accordance with principles of the present invention, as described in more detail below. Processor 200 performs instructions of the programs, and thereby operates in accordance with the present invention.

The programs may include one or more applications 210 that cause the server computer 102 to operate as a web server to handle access requests from user computers 108. In addition the programs may include one or more applications 212 that perform the find-a-card feature of the card association website. (The find-a-card application(s) may be incorporated with one or more other applications performing other features/functions of the card association web site.)

In addition, the programs may include one or more additional application programs 214 that handle other functions provided on the card association website. Although not indicated in the drawing, there may be still other application programs stored in the storage device 204, to perform non-website-related functions of the server computer 102. That is, the server computer 102 need not be dedicated solely to hosting the card association's website.

Any or all process steps of the programs stored in the storage device 204 may be read from a computer readable medium, such as a floppy disk, a CD-ROM, a DVD-ROM, a Zip™ disk, a magnetic tape, or a signal encoding the process steps, and then stored in a compressed, uncompiled and/or encrypted format. Processor-executable process steps being executed by processor 200 may typically be stored temporarily in RAM (not separately shown) and executed therefrom by processor 200. In alternative embodiments, hard-wired circuitry may be used in place of, or in combination with, processor-executable process steps for implementation of processes according to embodiments of the present invention. Thus, embodiments of the present invention are not limited to any specific combination of hardware and software.

Storage device 204 may also store a database 216 which stores data records representing various payment card products to be searched as part of the website's find-a-card feature. The number of payment card product records in the database 216 may in some embodiments be less than ten or twenty, but in other embodiments may number in the dozens or hundreds or more. Each record may include such information as the name of the card product, the name and/or identifying code for the issuing financial institution, the (issuer server) website address for online applications for the card product, card product attributes such as annual fee, interest rate (possibly including also introductory rate and/or transfer balance rate), grace period, reporting features, cardholder benefits (such as purchase protection or fraud protection), and cardholder rewards. Each entry may also indicate whether the issuer has authorized that pre-approval credit evaluations be performed for the particular product, if requested by the website visitor. If the issuer has authorized pre-approval credit evaluations for a particular card product, then the card product may be said to be “enabled” for pre-approval processing. In such cases, the database entries for the card product may also indicate the data communication address of the credit bureau server or other computer appointed to perform the pre-approval credit evaluations for the card product in question. (As noted above, the computer appointed to perform pre-approval credit evaluations may be a server or other computer operated by or for the issuer of the payment card product.) If pre-approval processing is enabled for a card product, the database entry for the card product may also contain data to indicate format parameters for requests to be sent to the computer appointed to perform the pre-approval credit evaluations.

In some embodiments, pre-approval-enabled card product entries may contain two website addresses for the issuer computer(s) which accept the customer's online application; that is, one of the two addresses may be used for applications that have been pre-approved, and the other for applications that have not been pre-approved.

The storage device 204 may also store other databases 218 used in connection with other features provided by the card association website.

There may also be stored in storage device 204 other unshown elements that may be necessary for operation of the association server 102, such as an operating system, a database management system, other applications, other data files, and “device drivers” for allowing processor 200 to interface with devices in communication with communication device 202. These elements are known to those skilled in the art, and therefore are not described in detail herein.

The credit bureau servers 104 and the issuer servers 106 may be conventional in their hardware aspects, but may be somewhat adapted, as described below, in their software aspects, to allow the credit bureau servers 104 and the issuer servers 106 to cooperate successfully with the enhanced find-a-card feature of the card association server 102, as disclosed herein.

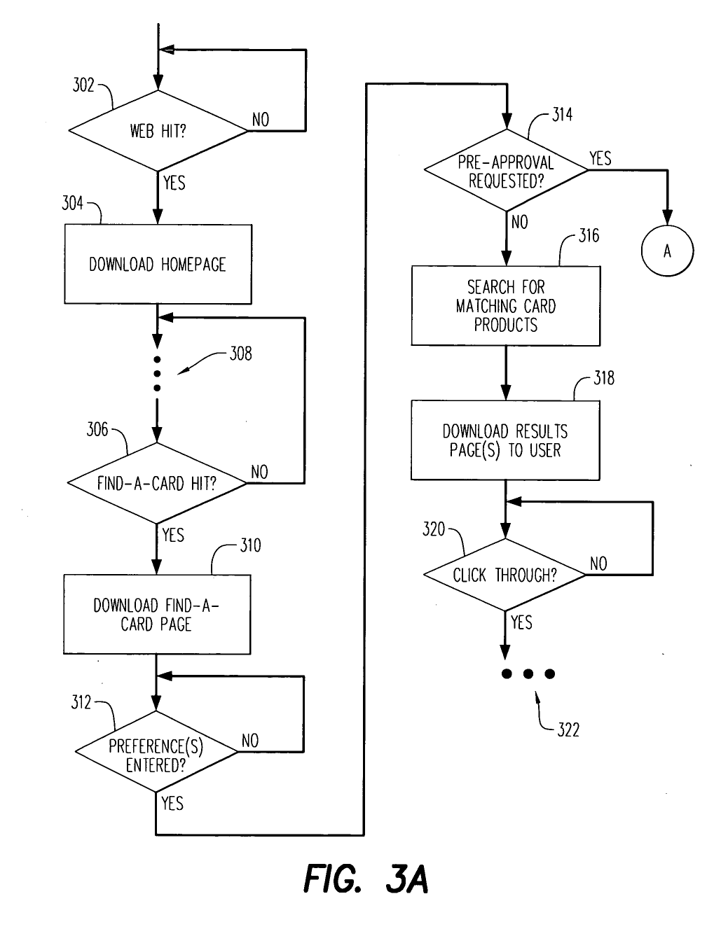

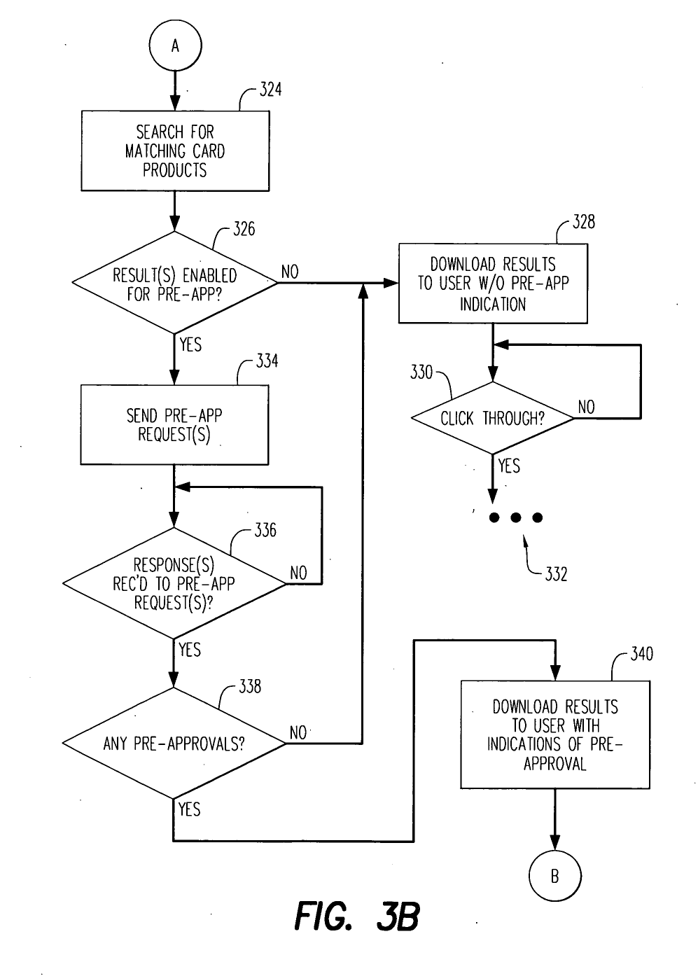

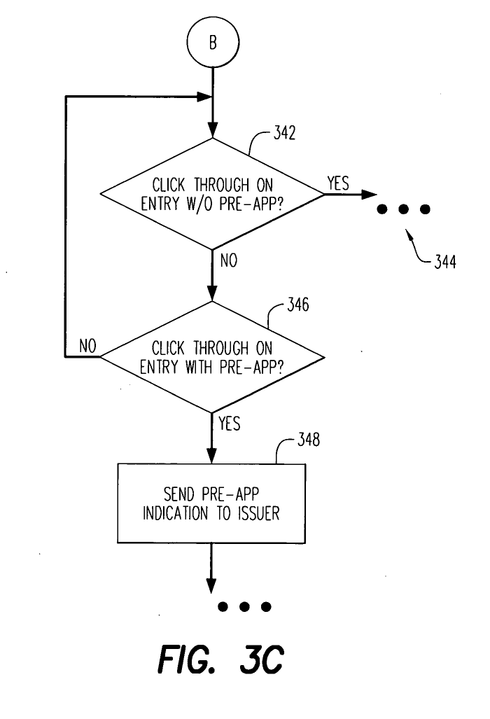

FIGS. 3A-3C together form a flow chart that illustrates a process that may be performed by the card association server computer 102 to implement an enhanced find-a-card feature in accordance with some embodiments of the invention.

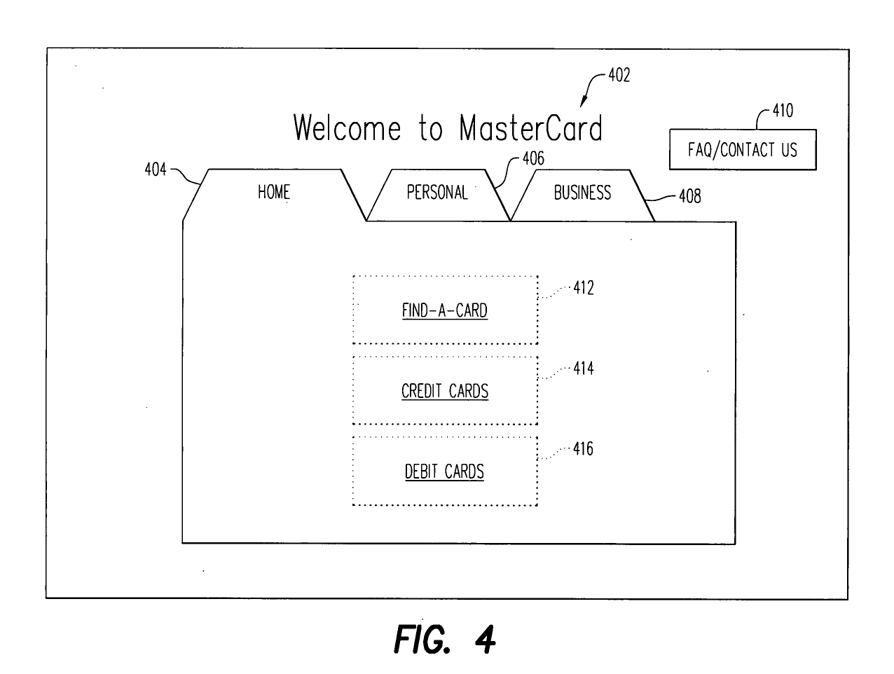

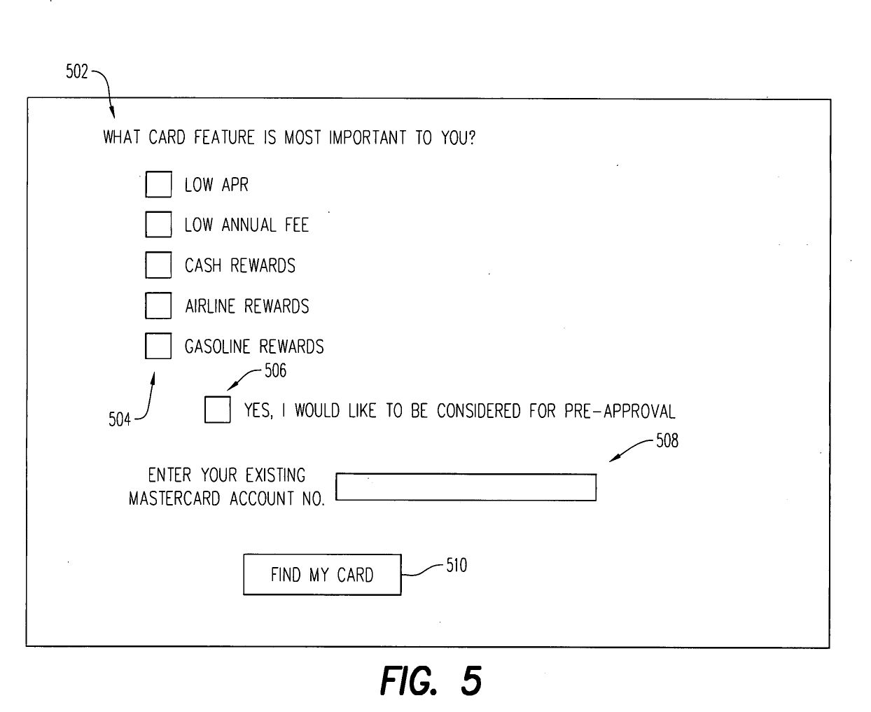

At 302 in FIG. 3A, it is determined whether a visitor has navigated to the card association's website using one of the user computers 108. If so, and as indicated at 304 in FIG. 3A, the card association server 102 may download to the user computer 108 a home or “welcome” webpage like the example screen display page illustrated in FIG. 4. (The screen display page shown in FIG. 4, like the other example screen display pages appended hereto as FIGS. 5-8, may be simplified examples. Actual screen display pages used in practical embodiments of the invention may contain additional and/or replacement elements, such as framing, additional text, additional navigation options, graphics, photographs, etc. In addition, there may be one or more additional display screens in the actual sequence of screens presented in practical embodiments. For example, in some embodiments, the website visitor may be prompted in the first screen downloaded to select a region of the world and/or a language, before receiving a download of a welcome screen akin to that shown in FIG. 4. For indications of additional website features that may be included, and/or additional screen display page features, the reader is invited to visit and explore the website maintained at www.mastercard.com by MasterCard International, Inc., the assignee hereof.)

Turning to FIG. 4, it will be noted that the screen display shown therein includes welcome text 402 and three navigation tabs: “Home” tab 404, “Personal” tab 406 and “Business” tab 408, with the “Home” tab 404 in the foreground. The screen display of FIG. 4 also includes an “FAQ/Contact Us” button 410 to allow the visitor to navigate to a frequently-asked-questions feature or to contact information also provided on the association website.

With the “Home” tab 404 in foreground, three hypertext links are shown: “Find-a-Card” link 412, “Credit Cards” link 414, and “Debit Cards” link 416. As will be seen, the “Find-a-Card” link 412 may be actuated by the visitor to access the enhanced find-a-card feature which is the primary subject of this disclosure. The “Credit Cards” link 414 may be actuated by the visitor to obtain access to information, menus and/or website features relating to credit card products branded by the card association, and the “Debit Cards” link 416 may be actuated by the visitor to obtain access to information, menus and/or website features relating to debit card products branded by the card association.

The “Personal” tab 406 may be clicked by the visitor to bring up a menu of information, etc. relating to payment card products intended for individual customers. The “Business” tab 408 may be clicked by the visitor to bring up a menu of information, etc. relating to payment card products intended for business customers. Alternative navigation paths via the tabs 406, 408 and/or the links 414, 416 may also allow the visitor to access the enhanced find-a-card feature disclosed herein.

Referring again to FIG. 3A, it is determined at 306 whether the visitor has actuated the “Find-a-Card” link 412. (The ellipsis 308 in FIG. 3A is suggestive of the process possibly receiving indications that the visitor has actuated other options on the welcome screen display page, thereby causing the process to branch in other directions which are not indicated in the drawing and which are not particularly pertinent to the present disclosure.) If it is found at 306 that the “Find-a-Card” link 412 has been actuated, then the association server 102 effectively has received an indication that the visitor is requesting to search for payment card products. Accordingly, the server 102 may, as indicated at 310 in FIG. 3A, download to the visitor's user computer 108 a screen display page like that shown in FIG. 5.

The screen display page of FIG. 5 includes a questionnaire 502 (in this case consisting of one question) to request the website visitor to indicate the visitor's preference or preferences in regard to the payment card that the visitor desires to acquire. In the particular example shown, the visitor is permitted to respond to the question (“What card feature is most important to you?”) by checking (i.e., by clicking with a mouse—not separately shown—of the visitor's user computer) one of the five checkboxes 504. It will be noted that each of the checkboxes 504 is associated with a respective payment card feature that may be preferred by the website visitor.

Instead of just one question the questionnaire may include two or more questions. For example, the questionnaire may include a question such as, “How important is (feature) to you, on a scale of 1 to 5?” for each of a number of different features. In another questionnaire format, the visitor may be asked to rank the importance of various features relative to each other.

In still another format, the visitor may be asked to “check all of the following features that are important to you”, and may be allowed to check more than one feature in response to the question.

Assuming for the moment that the question format shown in FIG. 5 is employed, it should be understood that the list of payment card features that the visitor is allowed to select from may be more or fewer in number than five. Moreover, the actual list of payment card features may include other card features in addition to or instead of one or more of the features listed. Other such features may include, for example, other types of rewards, cardholder benefits such as product warranties or fraud protection, reporting options, length of grace period, etc.

The questionnaire may contain additional questions (not shown) which are not related, or at least not directly related, to the website visitor's preferences for card product features. For example, the questionnaire may ask the visitor to indicate his/her state of residence, to rate his/her own credit history, to indicate whether he/she already has a credit card, and/or to indicate his/her current employment status. In a case where the website visitor has indicated that he/she is interested in a payment card in the name of a business, he/she may be asked to input data regarding the business, such as number of years in business, annual revenue, prior credit card usage, etc.

The screen display page shown in FIG. 5 also includes a checkbox 506 to request the visitor to indicate whether he/she wishes to be considered for pre-approval of a payment card product or products to be found in the search. If the visitor so indicates, he/she is also requested to enter information to identify himself/herself, such as the account number of an existing payment card account held by the visitor (as indicated at 508 in FIG. 5). In addition, or alternatively, the visitor may be asked to enter, for example, his/her name, social security number, date of birth and home zip code.

The screen display page of FIG. 5 also includes a button 510 that the visitor may actuate to indicate that he/she has completed entry of the required information and wishes the search for a payment card to proceed.

Although not shown on this or other drawings, at least some screen display pages may include one or more features that allow the website visitor to navigate back to the page shown in FIG. 5 and to change his/her indication(s) of what his/her preferred payment card features are.

Referring again to FIG. 5, it should be recognized that input from the user as to the user's payment card preferences and/or as to other information may be collected by other graphical user interface elements besides checkboxes. For example, sliders, radio buttons, text boxes, drop-down menus and/or other menu formats may be employed in addition to or instead of checkboxes.

Referring again to FIG. 3A, it is determined at decision block 312 whether the visitor has entered his/her card feature preference(s) by suitable interaction with the screen display page of FIG. 5. If not, the process idles. However, if it is determined that the visitor's preference(s) has (have) been entered, then it is next determined, at decision block 314, whether the visitor also requested that he/she be considered for pre-approval.

If a negative determination is made at 314 (i.e., if the visitor did not ask to be considered for pre-approval), then step 316 follows. At step 316 the server computer 102 searches the card offer database 216 to find one or more payment card products that match the visitor's preference(s). This may be done in a conventional manner or in any suitable manner. For example, the payment card products in the database 216 may have previously been sorted into categories that respectively satisfy the preference options included in questionnaire 502 (FIG. 5). For whatever preference the visitor selected, all of the card products in the corresponding category may be returned as matching the visitor's preference. In some embodiments, the order in which the matching card products are to be listed may be random (and may vary from search to search). In other embodiments, the issuers may be allowed to pay for preferred listing positions (akin to “sponsored links” for search engines), so that, for example, the first listed matching card product is the one from the issuer who paid the highest fee (or contracted for the highest “click-through” payment) with the payment card association.

In still other embodiments, in which for example visitors are permitted to specify one or more preferences and/or to weight or rank their preferences, a suitable algorithm may be employed with appropriate weightings or the like to generate scores for some or all of the payment card products in the database 216. In some embodiments, the payment card products may be ranked by their respective scores and may be listed in the search results according to rank. In some embodiments, only products having at least a minimum score are included in the search results. In some embodiments, one or more parameters entered/selected by the website visitor may cause one or more products to be suppressed from the search results. For example, if the website visitor expresses an interest in debit cards, any card product which is not a debit card may be suppressed from the search results.

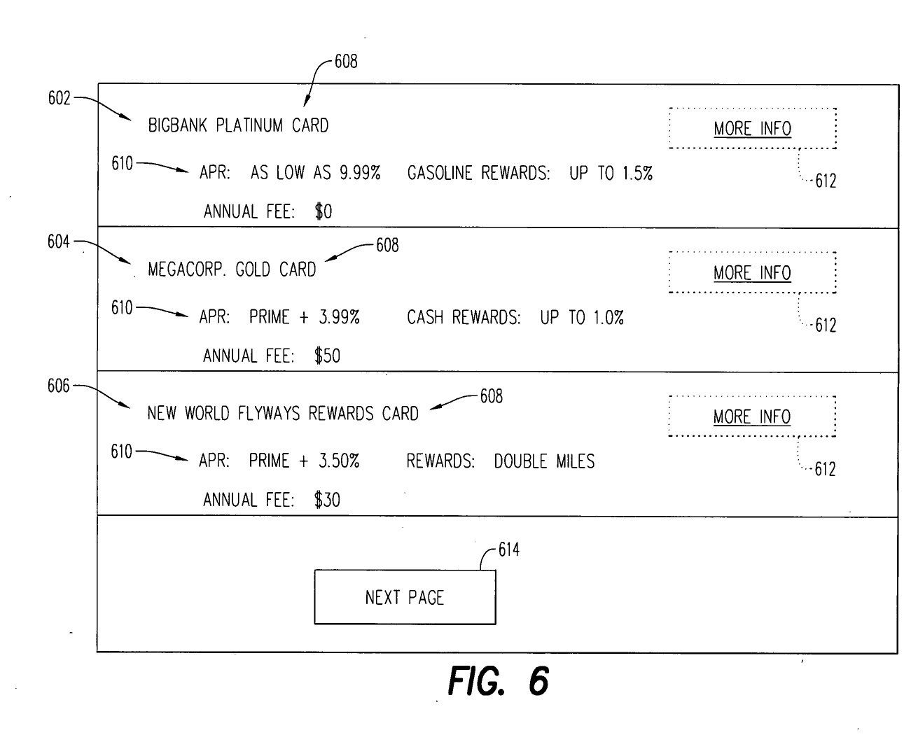

The results of the search made at step 316 may be presented to the website visitor by downloading one or more results page screen displays (as indicated at 318 in FIG. 3A), such as the screen display page shown in FIG. 6. The results page screen display may be like that presented in connection with conventional find-a-card features. As seen from FIG. 6, the results page may include a number of different entries 602, 604, 606. Each entry corresponds to a different respective payment card product found in the search at step 316. The order in which the entries are presented on the page may be based on a ranking of the respective payment card products arrived at during the search process, or may be random or based on other considerations, as described above relative to step 316. Each entry may include the name 608 of the respective payment card product, and information 610 concerning one or more features or attributes of the respective payment card product.

In accordance with conventional practice, each entry 602, 604, 606 may also include a respective hypertext link 612. The hypertext links 612, when actuated, allow the visitor to be redirected to the website of the respective issuer for the payment card product. In accordance with conventional practice, once at the issuer's website, the visitor may be allowed to complete an online application for the payment card in question, and/or to receive additional information concerning the payment card or may be prompted to request that a paper application for the payment card be mailed to the visitor or that an electronic version of the application form be downloaded to the visitor's computer to be printed out by the visitor. Assuming that the three payment card products indicated in FIG. 6 are issued by three different financial institutions, each of the hypertext links 612 shown in FIG. 6 may connect to a different issuer website. That is, the hypertext link 612 of entry 602 may point to the website of a first issuer, the hypertext link 612 of entry 604 may point to the website of a second issuer that is different from the first issuer, and the hypertext link 612 of entry 606 may point to the website of a third issuer that is different from the first and second issuers.

Also in accordance with conventional practices, the results page shown in FIG. 6 may include a button 614 to allow the visitor to navigate to the next page of search results.

Although three entries are shown on the screen display page of FIG. 6, in practice the number of entries on each page may vary, and may be for example, two, four, five, or more.

Referring again to FIG. 3A, decision block 320 represents a determination as to whether the visitor has “clicked through” (actuated) one of the hypertext links 612. If so, then the ellipsis 322 represents a conventional sequence of events resulting in the visitor being re-directed to the corresponding issuer website. In addition, the click through event may occasion accrual of a fee or charge from the issuer to the card association.

Considering again decision block 314, if a positive determination is made at that point (i.e., if it is determined that the visitor has requested consideration for pre-approval) then step 324 (FIG. 3B) follows decision block 314. At step 324 the server computer 102 searches the card offer database 216 to find one or more payment card products that match the visitor's preference(s). In some embodiments, this may be done in the same manner as described above in connection with the description of step 316. For example, the search for matching payment card products may be performed in a conventional manner. In other embodiments, however, the search for matching payment card products may be performed differently (from step 316) if the visitor has requested consideration for pre-approval. For example, in step 324 consideration may be given in ranking the payment card products as to whether some of the potentially matching payment card offers are enabled for pre-approval. If so, then the ranking(s) of one or more of the pre-approval-enabled payment card products may be improved relative to other payment card products. In some embodiments, all pre-approval-enabled matching payment card products may be ranked ahead of all other matching payment card products. In other embodiments, only pre-approval-enabled payment card products may be returned as matching results. In still other embodiments, payment card products may receive a certain number of points in the scoring process (if any) for being pre-approval-enabled. In yet other embodiments, the highest ranked pre-approval-enabled payment card product is automatically made the number one ranked product in the search results. In still other embodiments, the highest ranked pre-approval-enabled payment card product for the first page of results (say in the first three, four or five top-ranked payment card products) is re-ranked, if necessary, so that it becomes the highest ranked payment card product over-all.

In connection with both steps 324 and 316, when the association server 102 determines that a payment card product matches the website visitor's preference or preferences, it may be said that the association server 102 has selected the payment card product in question for presentation or possible presentation to the website visitor.

In some cases, in some embodiments, none of the matching payment card products found in the search at 324 may be pre-approval-enabled. In other cases, in some embodiments, none of the payment card products on the first results page is pre-approval-enabled. Since governmental regulations may require individuals to be informed whenever they have been pre-approved for a payment card, it may be desirable not to perform pre-approval processing with respect to payment card products that will not appear on the first results page, since it cannot be known with certainty that the visitor will navigate to results pages other than the first results page. Thus, to deal with the cases referred to in this paragraph, there may be a decision block 326 following step 324 in FIG. 3B. At decision block 326 it is determined whether any of the matching payment card products are pre-approval-enabled and/or whether any payment card product to appear on the first results page is pre-approval enabled. If a negative determination is made at 326, then step 328 follows.

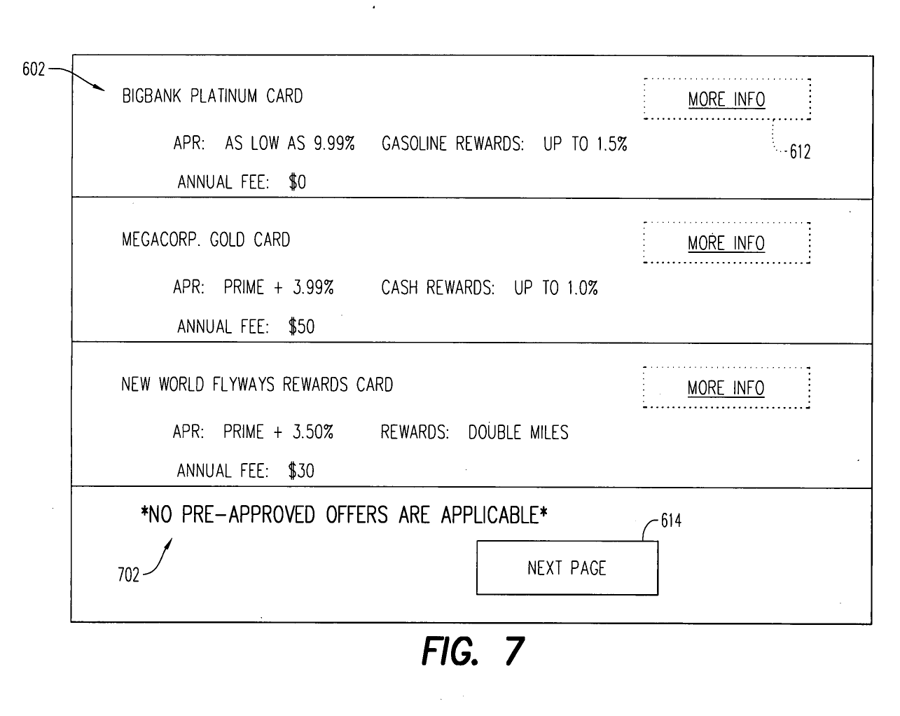

At step 328, the results of the search made at step 316 may be presented to the website visitor by downloading one or more results page screen displays such as the screen display page shown in FIG. 7. The screen display page shown in FIG. 7 may be the same as the screen display page shown in FIG. 6, except that the screen display page of FIG. 7 may also include a legend 702 to the effect that no pre-approved payment card product offers are now being presented to the website visitor.

As before, the visitor may click through one of the hypertext links in the results page entries shown in FIG. 7 to be redirected to the corresponding issuer website. Decision block 330 and ellipsis 332 in FIG. 3B may have the same meaning as the corresponding portions (decision block 320 and ellipsis 322) of FIG. 3A, as discussed above.

Considering again decision block 326, if a positive determination is made at that point (i.e., if it is determined that at least one of the matching payment card products is pre-approval-enabled and/or that at least one of the matching payment card products to appear on the first results page is pre-approval-enabled), then step 334 follows decision block 326. At step 334 the association server 102 may send one or more requests for a pre-approval credit evaluation to one or more of the credit bureau servers 104. For example, the association server 102 may send a separate pre-approval credit evaluation request for each pre-approval enabled payment card product that will fall on the first results page. In some embodiments, the association server may request at most one pre-approval credit evaluation; in some embodiments, it may request a pre-approval credit evaluation only if the top ranked payment card product is pre-approval enabled.

In some embodiments, the association server sends a request for a pre-approval credit evaluation for the top-ranked payment card product which is pre-approval enabled, whether or not the product would fall on the first results page based on the score assigned to the product. If pre-approval is granted, then that product would be moved to the first results page, e.g., to the top of the first results page. If pre-approval is not granted, then that product would not be moved up in the product ranking, according to this scenario.

In any event, assuming that step 334 is reached, then as to each payment card product for which pre-approval processing is to be requested, the association server 102 accesses the database record for that product to determine the destination (e.g., credit bureau computer) for the request, and also to determine the format for the request. The association then sends the request, including information which identifies the website visitor (prospective applicant for the credit card), to the server computer having the address indicated in the applicable database record. As would be expected from previous discussion, the information to identify the visitor may include the account number for a payment card account that the website visitor already holds, and/or the website visitor's name, social security number, date of birth, home zip code.

The information to identify the person (website visitor) who is to be the subject of the pre-approval credit evaluation may be one of a number of parameters included in the request from the association server 102 to the credit bureau server 104 or other computer that is to perform the pre-approval credit evaluation. Other parameters may include a sequence number and a routing number. The latter may identify the association server 102 as the source of the request (and as the proper destination for the response to be made to the request). The former may identify the specific request among the various requests that may be made by the association server. Still another parameter may identify the issuer for the payment card product in question and/or the credit policy to be applied in performing the pre-approval credit evaluation.

The credit bureau server 104 may perform the pre-approval credit evaluation in essentially a conventional manner. That is, the credit bureau server may retrieve/calculate the credit history/credit score and/or other information concerning the prospective holder of the payment card account, and may also retrieve/access the credit policy to be applied in accordance with the instructions of the issuer of the payment card product. The credit bureau server then determines whether the credit history/credit score passes the credit policy. If so, then the credit bureau sends a message to the association server to indicate that pre-approval is granted for the website visitor and payment card product in question. If not, then the credit bureau server sends a message to the association server to indicate that pre-approval is not granted.

The foregoing sequence of events assumes that the information to identify the prospective payment card holder is sufficient to allow the credit bureau server to identify one and only one individual. If such is not the case, again the credit bureau server may send a message to the association server to indicate that pre-approval was not granted. The code used in this case may or may not be the same as the code used in the “not granted” message referred to in the previous paragraph.

In some embodiments, if pre-approval is granted, the message sent from the credit bureau server to the association server may include a code that will identify the pre-approval transaction for further purposes. As will be seen, the code (which may be akin to a “coupon code” included with pre-approved payment card account solicitations sent by mail) may be used in interactions between the association server and the issuer server and between the issuer server and the credit bureau server to facilitate the prospective payment card holder's application for the payment card product.

Referring once more to FIG. 3B, after step 334, in which the association server sends out one or more requests for pre-approval processing, the association server awaits responses to these requests, as indicated at decision block 336. Once the response(s) is (are) received, the association server determines, at decision block 338, whether any response indicates that pre-approval was granted. If such is not the case, then the process advances to the previously described steps 328, 330, in which the association server downloads, to the user computer of the website visitor, a results page like that shown in FIG. 7. However, if at least one response indicates that a pre-approval credit evaluation performed by the credit bureau server resulted in granting pre-approval, then step 340 follows step decision block 338.

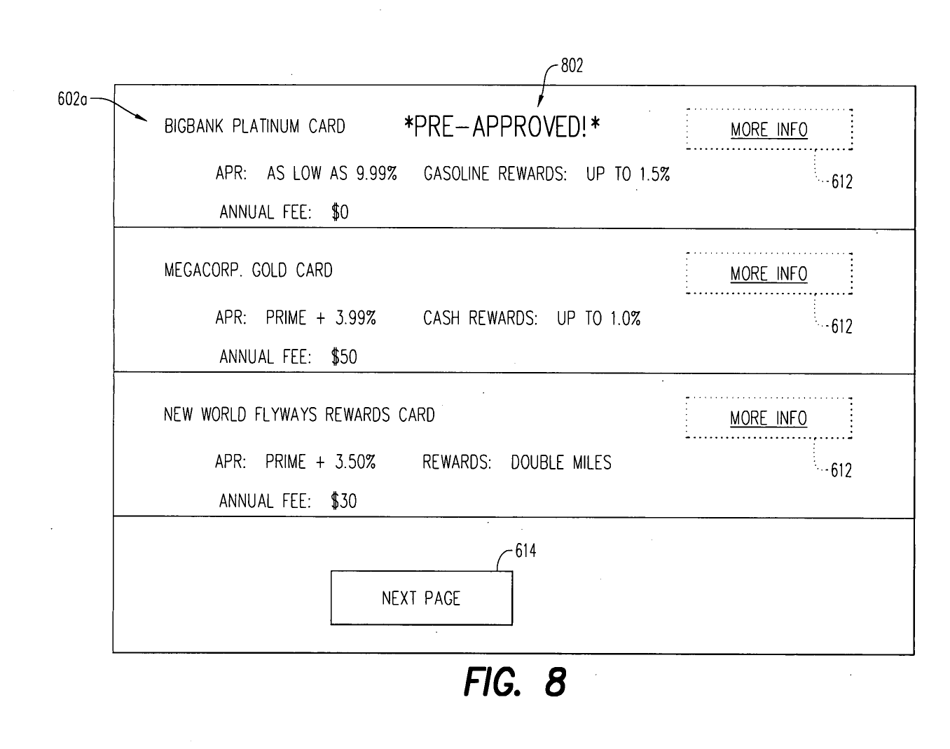

At step 340, the association server downloads, to the user computer of the website visitor, a results display page like that shown in FIG. 8. The display page shown in FIG. 8 may differ from that of FIG. 6 in that at least one of the entries includes an indication (shown at 802 in entry 602a in FIG. 8) that the website visitor has been pre-approved for the corresponding payment card product. The entry 602a shown in FIG. 8 may otherwise be the same as the entry 602 shown in both FIGS. 6 and 7. However, in some embodiments the hypertext link 612 in the entry 602a shown in FIG. 8 may be different (though perhaps not visibly so) from the hypertext link 612 in entry 602 in FIGS. 6 and 7. In particular, the link in entry 602a (FIG. 8) may point to a different webpage, though also maintained by or for the payment card issuer, from the webpage pointed to by the link in entry 602 (FIGS. 6 and 7). Therefore, by receiving a hit at the webpage pointed to by the link in entry 602a, the issuer or its agent is informed that the applicant for the payment card has been pre-approved. Accordingly, an application at the latter webpage may be handled somewhat differently from an application at the webpage pointed to by the link in entry 602. Examples of such differences in handling an application will be discussed below.

From previous discussion, it will be appreciated that more than one entry in the display page downloaded at step 340 may have an indication like 802, in that more than one pre-approval may have been requested and granted, in some cases in some embodiments.

Following step 340 in FIG. 3B is decision block 342 in FIG. 3C. At decision block 342 it is determined whether the website visitor has clicked through the hypertext link in an entry (in the display page of FIG. 8) which lacks an indication that the website visitor has been pre-approved for the corresponding payment card product. If so, the effect is the same as in decision blocks 320 or 330 and the corresponding ellipses 322, 332 (reflected at 344 in FIG. 3C). If the website visitor does not click through the link in an entry for which pre-approval is not indicated, then it is determined (at decision block 346) whether the website visitor has clicked through the link in an entry for which pre-approval is indicated. If so, in some embodiments, step 348 may follow. At step 348, the association server may send an indication to the issuer server to the effect that the website visitor who just clicked through has been pre-approved for the payment card product in question. In some embodiments, the indication may include or take the form of a “coupon code” that the association server had previously received from the credit bureau server as a reference to the pre-approval granted by the credit bureau server. The issuer server may then use the coupon code while accessing the credit bureau server to receive from the credit bureau server the identity of the website visitor as well as other information concerning the website visitor (such as home address, telephone number, etc.). With this information, the issuer server may populate the online application for the payment card with the data specific to the website visitor. Consequently, completion of the online application may require only minimal effort on the part of the website visitor, such as consenting to terms and conditions, receiving and acknowledging credit terms, etc. Alternatively, the card association server may send to the issuer server data to populate at least a portion of the online application to be completed at the issuer's website. At least some of this information may have been received by the association server from the decision engine/credit bureaus server. Again, this approach may minimize the effort required for the website visitor to complete his/her application for the payment card product.

In some embodiments, only a portion of the application is pre-populated at the issuer's website based on information received from the association server, while the balance of the application data may be retrieved by the issuer server from the decision engine/credit bureau server (e.g., in a batch mode at night) and/or entered by the applicant/website visitor. These approaches may be favorable from the point of view of maintaining security for the applicant's information.

To further enhance security, in some embodiments, data to be received by the association server from the decision engine/credit bureau server and then passed on to the issuer server may be encrypted so that the association server is unable to read such data. For example, public key encryption may be employed.

With this feature and/or in other respects, the “batch of one” real-time pre-approval process illustrated in FIGS. 3A-3C may improve over-all convenience for the prospective payment card applicant. Moreover, this process may improve the effectiveness both of the find-a-card feature offered by the payment card association and of the marketing efforts of the card issuers (or at least of the issuers who participate in the pre-approval feature).

The scenario described above which occurs upon the website visitor “clicking through” a pre-approved results page entry may be varied in a number of respects. For example, the association server 102 need not provide any indications to the issuer server of a coupon code or the like, and need not even indicate that the click-through is from a pre-approved results page entry. The issuer server may respond to the click-through by taking a conventional on-line payment card application from the website visitor and applying (e.g., via the same credit bureau) the same credit policy that resulted in the pre-approval of the website visitor. This credit policy may or may not be the same as the credit policy applied to the applicants who are not pre-approved.

In some embodiments, if the visitor clicks the “next page” button 614 shown in FIG. 8 (or in FIG. 6 or FIG. 7) to access the next results page, and if one or more of the entries on that page corresponds to a pre-approval-enabled payment card product, then the association server may immediately send one or more additional pre-approval requests for the pre-approval enabled products. Consequently, when the next results page is downloaded, it may include one or more “Pre-Approved” indications, assuming that one or more of the additional pre-approval requests is granted.

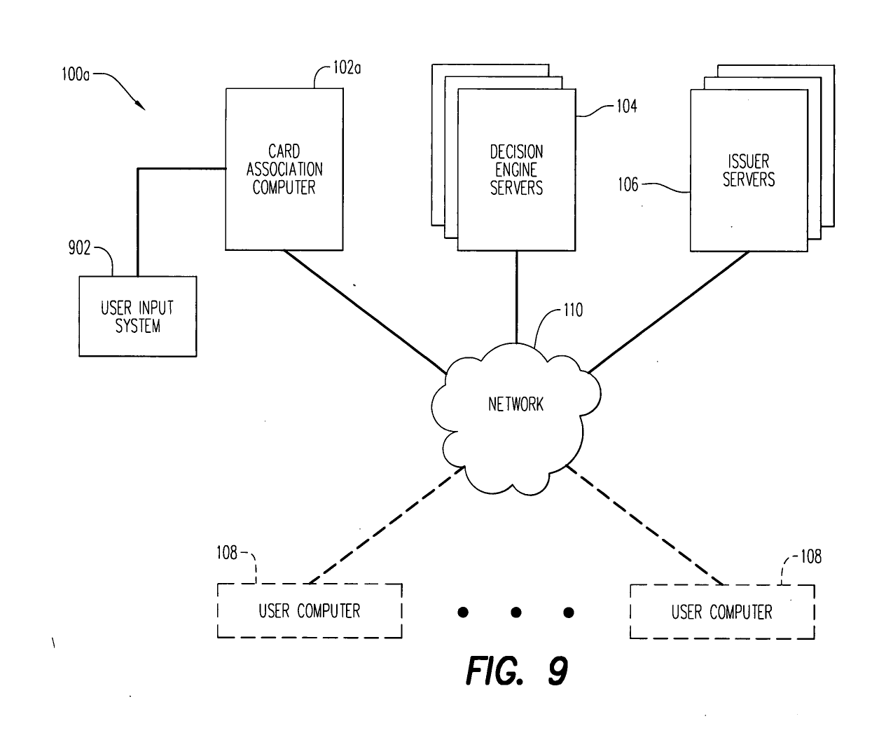

FIG. 9 is a block diagram representation of aspects of a payment card system 100a provided in accordance with some alternative embodiments of the present invention.

The system 100a of FIG. 9 may differ from the system 100 of FIG. 1 in that the payment card association may operate a card association computer 102a which need not necessarily be a web server. (Thus user computers 108 shown in phantom in FIG. 9 need not necessarily interact with the card association computer 102a and/or need not form part of the system 100a.) In addition to or as an alternative to receiving user card preference input via a website, the card association computer 102a may be coupled to an alternative user input system 902, which may for example include an interactive television system (not shown separately from user input system 902) or a conventional interactive voice response unit (IVRU—not separately shown from user input system 902). Thus the card association computer 102a may receive via the input system 902 input from users regarding the user's preferences for payment card features and attributes. As another alternative, the input system 902 may include or be constituted by a conventional call center in which calls from and/or to prospective customers are handled by human operators.

The functions described herein may be divided among the system components in various ways, and the system may be modified while continuing to operate in accordance with principles of the present invention. For example, the issuer servers may perform at least some of the functions described above as being performed by the credit bureau servers. For example, the issuer servers may store the credit policy or policies to be applied for purposes of the pre-approval credit evaluations. Further, the issuer servers may perform pre-approval credit evaluations by retrieving from a credit bureau the credit history/score for the website visitor and by determining whether such information results in the website visitor passing the applicable credit policy.

In some embodiments, the functions of the payment card association server computer may be divided among two or more computers, of which one or more may or may not be operated by or on behalf of the payment card association.

The flow charts and process descriptions herein should not be understood to imply a fixed order of performing process steps. Rather, the process steps may be performed in any order that is practicable.

As used herein and in the appended claims, the term “payment card” should be understood to refer not only to card shaped items bearing magnetic stripes but also to other devices, whether or not card shaped, used to input an identification number for accessing a financial account. Thus “payment card” also includes devices that report account access identification information by proximity coupling, radio frequency identification (RFID) techniques, and the like. Either or both of credit cards and debit cards are to be considered payment cards.

The above discussion has generally described the enhanced find-a-card feature in the context of a website visitor wishing to acquire a payment card for personal use. However, the teachings of this disclosure are also generally applicable to a find-a-card feature offered to allow searching for a payment card for business use. Indeed, the same card association website may offer two find-a-card features—one for personal payment cards and the other for business payment cards. The two find-a-card features may operate in quite similar ways, or may employ different ones of the variations described herein.

The above discussion also includes a brief mention of possibly allowing payment card issuers to pay fees, or agree to “per click” payments, to obtain improved placement in the results listings. In addition, or alternatively, the payment card association may charge payment card issuers for other aspects of the enhanced find-a-card feature, such as storing payment card products in the database 216, per occurrence charges for each search in which the issuer's payment card product is returned as a result, per occurrence charges for each occasion on which the issuer's payment card product is included in a results page downloaded to the website visitor, per occurrence charges for each “click through” to the issuer's webpage, per occurrence charges for each time the card association requests pre-approval processing for the issuer's payment card products, per occurrence charges for each time the card association receives a negative response to such a request, and/or for each time the card association receives a positive response to such a request, etc.

Furthermore, the payment card association may charge back issuers for charges rendered by credit bureaus to the association for pre-approval credit evaluations performed by the credit bureaus. In addition or alternatively, the credit bureaus may directly charge the payment card issuers for pre-approval credit evaluations which apply the issuers' credit policies.

In some embodiments, granting of pre-approval with respect to a particular payment card product may improve (e.g. move to the top ranking) the position of that payment card product in the search results to be downloaded to the website visitor. For example, in some embodiments, the payment card association server may “walk” down the results list and may keep requesting pre-approval processing with respect to each pre-approval-enabled payment card product until either one such request results in pre-approval being granted or the pre-approval-enabled payment card products in the search results are exhausted. Of course, the payment card association server may refrain from requesting pre-approval processing of the next pre-approval-enabled payment card product in the search results until a negative response is received as to the currently pending request for pre-approval processing.

In some embodiments, in addition to or instead of providing the website visitor with a “Pre-Approved” indication in an entry in a results display page, the payment card association server may provide such an indication in a screen display pop-up, as an automated voice message to the website visitor's cellular telephone, as a text (e.g., SMS) message to the website visitor's cellular telephone, by a letter or as a special message on a payment card account or bank account statement sent by mail to the website visitor.

In some embodiments, the credit bureau servers may directly send messages to the issuer servers to inform the issuer servers when the credit bureau servers have granted pre-approvals for the respective payment card products issued by the issuers and/or to give the issuer servers advance notice that a “click-through” from a pre-approved website visitor may be forthcoming.

In some embodiments, when the website visitor clicks through on a payment card product entry with a “Pre-Approved” indication, the association server may send data to the issuer server such as the website visitor's name, address, etc., to allow the online application form presented to the website visitor by the issuer server to be pre-populated with the website visitor's information.

In some embodiments, the enhanced find-a-card feature may be provided by a computer other than the server computer which hosts the payment card association website. For example, when the website visitor, at the payment card association website, clicks through the “find-a-card” link 412 shown in FIG. 4, he/she may be re-directed to a website maintained by a contractor for the payment card association or an affiliated organization of the payment card association.

In some embodiments, clicking through the link 612 in the “pre-approved” entry 602a may cause the website visitor to be re-directed to an online payment card application page maintained at the credit bureau server, whereas clicking through a non-pre-approved entry causes the website visitor to be re-directed to the issuer website.

In some embodiments, the credit bureau (or issuer) server may make determinations other than granting or declining pre-approval in response to a request for pre-approval processing from the payment card association server. For example, the credit bureau (or issuer) server may determine what annual fee and/or interest rate will be offered to the website visitor on a pre-approved basis as a function of the website visitor's creditworthiness. For example, website visitors having better creditworthiness may be offered more favorable terms than those who are less creditworthy. Accordingly, the credit bureau or issuer server may, in responding to the request from the association server, indicate at least some of the terms to be listed in the “pre-approved” entry presented in the results display page for the payment card product in question. In some embodiments, the request from the association server, or instructions provided by pre-arrangement from the payment card association to the credit bureau, may indicate that the credit bureau is not to grant pre-approval unless the issuer's credit policy allows it do so on terms that are relatively favorable.

More generally, the card association server may request the decision engine/credit bureau server to determine whether the website visitor is eligible for one or more other promotional offers in addition to or instead of pre-approval and/or favorable payment card account terms. For example, the decision engine server may determine whether the website visitor is eligible to receive one or more financial benefits related to use of a particular payment card product. The financial benefits may include “bonus points” or “bonus miles”, free printed periodical or other subscriptions, telephone calling minutes, free admissions to seminars, free hotel stays or car rentals, etc. Accordingly, instead of or in addition to asking the website visitor whether he/she wishes to be considered for pre-approval, the website may ask him/her whether he/she wishes to opt-in for promotional offers.

The screen displays shown in FIGS. 4-8 are only examples of numerous ways in which information may be presented to and/or solicited from the website visitor. Numerous modifications may be made to these example screen displays. For example, the displays of FIGS. 5 and 6 (or 7 or 8) may be combined so that search results may be presented on the same page with the “questionnaire”. Moreover, in such a case, the website visitor may be permitted to update his/her preferences, which may lead to automatic updating of the search results.

The above discussion has indicated that website visitors may be redirected from the payment card association website to an issuer's website to apply for a card product of the issuer. However, the system may encompass other and/or additional mechanisms for allowing the website visitor to apply for card products. For example, the website visitor may be allowed to initiate a web-conference (audio or audio-video) or a live online chat session with a live human agent of the issuer for the purpose of applying for a card product. As another possibility, the website visitor may be permitted to request a telephone call (e.g., immediately) from a live agent of the issuer who will take the website visitor's card product application over the telephone.

For the most part the above disclosure has been presented in aspects relevant to credit cards, but the teachings hereof may also be relevant, in at least some cases, to debit cards. This is particularly true with respect to debit cards that include an account overdraft feature.

In some embodiments, if the association server receives an indication of pre-approval for one payment card product issued by a particular issuer, the association server may also treat some or all other payment card products issued by the same issuer as having been pre-approved.

Although the present invention has been described in connection with specific exemplary embodiments, it should be understood that various changes, substitutions, and alterations apparent to those skilled in the art can be made to the disclosed embodiments without departing from the spirit and scope of the invention as set forth in the appended claims.

What is claimed is:

1. A method comprising:
receiving input at a website from a user to indicate at least one preference of the user in regard to a payment card product that the user wishes to acquire;
selecting at least one payment card product from a plurality of payment card products, said selected at least one payment card product being selected based at least in part on the at least one indicated preference of the user;
requesting a pre-approval credit evaluation of the user with respect to the selected at least one payment card product;
receiving a result of the pre-approval credit evaluation; and
downloading a display page to the user to indicate the selected at least one payment card product and to indicate that the user has been pre-approved for the selected at least one payment card product.

2. The method of claim 1, wherein:
the downloaded display page includes a hypertext link to direct the user to a website maintained by or for an issuer of at least one of the selected at least one payment card product.

3. The method of claim 1, wherein the downloaded display page includes a plurality of entries, each of said entries corresponding to a respective payment card product.

4. The method of claim 3, wherein each of said entries includes a respective indication that the user has been pre-approved for the corresponding respective payment card product.

5. The method of claim 3, wherein at least one but not all of said entries includes a respective indication that the user has been pre-approved for the corresponding respective payment card product.

6. The method of claim 3, wherein a first one of said entries corresponds to a respective payment card product offered by a first issuer, and a second one of said entries corresponds to a respective payment card product offered by a second issuer different from the first issuer.

7. The method of claim 1, further comprising:
receiving input at said website from said user to identify said user;
and wherein the requesting the pre-approval credit evaluation includes transmitting data to identify said user.

8. The method of claim 7, wherein the transmitting data includes transmitting data to a credit bureau.

9. The method of claim 1, further comprising:
receiving from the user an indication that the user has selected one of the payment card products.

10. The method of claim 9, further comprising:
transmitting, to an issuer of one of said payment card products, a code indicative of said result of said pre-approval credit evaluation.

11. The method of claim 10, wherein said transmitting said code is performed in response to receiving said indication from said user.

12. The method of claim 9, further comprising:
transmitting, to an issuer of one of said payment card products, information for populating an online application form for said one of said payment card products.

13. The method of claim 12, wherein said transmitting said information for populating is performed in response to receiving said indication from said user.

14. A method comprising:
receiving a request from a user to search for payment card products;
requesting the user to indicate at least one preference of the user concerning the payment card products;
requesting the user to indicate whether the user wishes to be considered for pre-approval for at least one of the payment card products;
requesting the user to enter information that identifies the user;
receiving input from the user to (a) indicate said at least one preference, (b) indicate that the user wishes to be considered for pre-approval for at least one of the payment card products, and (c) identify the user;
searching a database of said payment card products to identify a plurality of said payment card products that match the user's at least one preference;
determining one of said identified plurality of payment card products that is enabled for pre-approval processing;
sending data that identifies the user to a third party appointed to perform pre-approval processing for the determined one of said payment card products;
receiving an indication from said third party that the user is pre-approved for the determined one of said payment card products; and
downloading a results page to the user, the results page including a plurality of entries, one of said entries identifying said determined one of said payment card products and indicating that the user is pre-approved for said determined one of said payment card products, said one of said entries including a hypertext link to a website maintained by or for an issuer of said determined one of said payment card products.

15. The method of claim 14, further comprising:
receiving an indication that the user has actuated said hypertext link.

16. The method of claim 15, further comprising:
receiving from said third party a code that represents a pre-approval transaction performed by said third party with respect to said user; and
transmitting said code to said website in response to receiving the indication that the user has actuated said hypertext link.

17. The method of claim 14, wherein the information requested from the user includes the user's name, social security number and date of birth.

18. The method of claim 14, wherein the information requested from the user includes an account number for an existing payment card account held by the user.

19. The method of claim 14, wherein the request from the user and the input received from the user are received at a website different from the website maintained by or for said issuer.

20. The method of claim 14, wherein the database includes payment card products from a plurality of issuers.

21. A method comprising:
downloading, to a first user, a first display page indicative of a first offer for a payment card product, said first display page including a first hypertext link to a first webpage maintained by or for an issuer of said payment card product; and
downloading, to a second user, a second display page indicative of a second offer for said payment card product, said second offer being pre-approved, said second display page including a second hypertext link to a second webpage maintained by or for said issuer;
said first webpage for processing non-pre-approved applications for said payment card product, said second webpage for processing pre-approved applications for said payment card product.

22. The method of claim 21, wherein:
downloading the first display page is performed in response to receiving an indication that the first user is not pre-approved for said payment card product; and
downloading the second display page is performed in response to receiving an indication that the second user is pre-approved for said payment card product.

23. The method of claim 21, wherein:
downloading the first display page is performed in response to receiving an indication that the first user does not wish to be considered for pre-approval for payment card products; and
downloading the second display page is performed in response to receiving an indication that the second user is pre-approved for said payment card product.

24. A method comprising:
receiving input from a user to indicate at least one preference of the user in regard to a payment card product that the user wishes to acquire;
selecting at least one payment card product from a plurality of payment card products, said selected at least one payment card product being selected based at least in part on the at least one indicated preference of the user;
requesting a determination as to whether the user is eligible for at least one promotional offer with respect to the selected at least one payment card product; and
providing information to the user to indicate the user's eligibility for the at least one promotional offer.

25. The method of claim 24, wherein the input from the user is received via a web site.

26. The method of claim 24, wherein the input is received via a telephone interactive voice response unit (IVRU).

27. The method of claim 24, wherein the input from the user is received via an interactive television system.

28. The method of claim 24, wherein the promotional offer is pre-approval of the user's application for the selected at least one payment card product.

29. The method of claim 24, wherein the promotional offer is a financial benefit related to the user's use of the selected at least one payment card.
